(19) United States
(12) Patent Application Publication
(10) Pub. No.: US 2016/0132216 A1
(43) Pub. Date: May 12, 2016

(54) BUSINESS-TO-BUSINESS SOLUTION FOR PICTURE-, ANIMATION- AND VIDEO-BASED CUSTOMER EXPERIENCE RATING, VOTING AND PROVIDING FEEDBACK OR OPINION BASED ON MOBILE APPLICATION OR WEB BROWSER

(71) Applicant: Pixrating Ltd., Budapest (HU)

(72) Inventor: Tamás Járdán, Eger (HU)

(21) Appl. No.: 14/935,713

(22) Filed: Nov. 9, 2015

Related U.S. Application Data
(60) Provisional application No. 62/076,899, filed on Nov. 7, 2014.

(51) Int. Cl. G06F 3/0484; G06Q 30/02; G06F 3/0482; G06T 11/60; G06T 13/80

(52) U.S. Cl. CPC G06F 3/04842; G06T 11/60; G06T 13/80; G06F 3/04845; G06F 3/0482; G06Q 30/0282

(57) ABSTRACT

A Business-to-Business solution for picture-, animation- and video-based customer experience rating, voting and providing feedback or opinion in a wide range of industries based on mobile application or web browser; extended with social rating function for capturing, choosing, editing and sharing picture-based stories, relations, opinions, ratings, preferences or comparisons to social media sites.

### CROSS-REFERENCES TO RELATED APPLICATIONS

This application claims the benefit of U.S. provisional patent application Ser. No. 62/076,899 filed on Nov. 7, 2014, and incorporated herein by reference.

### BACKGROUND

There is a very large consumption of electronic social media in the world today, including joining and sharing on popular portals, like Facebook, Instagram and Twitter. The typical characteristics of social media usage are impulsive and picture-based. Users prefer simple, easy and natural way of sharing their own or others' inspiring or funny content, which must be attractive and creative to gain attention. Users want smart solutions what can immediately reflect on the moment of inspiration. Moreover, users want to catch a moment of everyday life and share it immediately—together with their reflections—on their favorite social media sites, blogs, or with their friends.

Typical rating solutions ask questions in electronic questionnaires where customers can provide their opinions, mostly on 5-star or 3-star scales, or 5-scale smilies set. Feedback is usually asked in email or on a company website or on special hardware equipment, and most of these questionnaires are totally separated from the actual customer experience (e.g., in time and/or in place). Most special hardware equipment which is installed around the points-of-sale has very limited functionalities and can ask only limited and unsophisticated questions; moreover it cannot be analyzed how many false answers were given, e.g.: one user gives 10 answers at the same time by pushing the buttons of the tool. These are far away from the everyday way of using social media sites with personal accounts.

### SUMMARY

This application relates generally to a pixrating solution which enables businesses, corporations, and non-profit organizations to involve their customers and partners into a rating, voting, opinion, or feedback process through predefined picture-, animation- and video-based campaigns, building on the right moment of customer experience. The solution is implemented in an attractive and fascinating way, similarly to the (contemporary) everyday habits of sharing and using the most popular social media sites.

Provided are a plurality of example embodiments, including, but not limited to, a method of editing photographs using a personal mobile computer device customized with specialized software for distributing commentary, opinions, and/or ratings, the method comprising the steps of:
displaying a photograph on a display of the mobile computer device to provide a picture layer for editing;
executing the specialized software on the personal mobile computer device to provide photograph editing tools via a user interface on the mobile computer device to allow the user to edit the photograph picture layer;
executing the specialized software on the personal mobile computer device to provide an object insert user interface on the mobile computer device to enable the user to select one of a plurality of different object types for adding to the picture layer, wherein each one of the plurality of different object types are configured to communicate an opinion or rating;
executing the specialized software on the personal mobile computer device to provide an object edit user interface on the mobile computer device to enable the user to edit the selected one of the plurality of different object types, wherein
said picture layer with inserted edited objects results in a composed picture;
executing the specialized software on the personal mobile computer device to provide a share interface on the mobile computer device to enable the user to select one of a plurality of options for sharing the composed picture; and
the personal mobile computer device executing a communication function based on the selected one of the options for sharing the composed picture to share the composed picture with another computing device.

Also provided is a method of editing photographs using a personal mobile computer device customized with specialized software for distributing commentary, the method comprising the steps of:
displaying a photograph on a display of the mobile computer device to provide a picture layer for editing;
executing the specialized software on the personal mobile computer device to provide photograph editing tools via a user interface on the mobile computer device to allow the user to edit the photograph picture layer;
executing the specialized software on the personal mobile computer device to provide a text object insert user interface on the mobile computer device to enable the user to select a text object type configured to accept and display textual information;
executing the specialized software on the personal mobile computer device to provide a rating sticker object insert user interface for selecting a desired one of a plurality of different rating sticker objects from a library, wherein the rating sticker objects are configured to use graphical objects to display a desired rating;
executing the specialized software on the personal mobile computer device to provide a rating sticker object edit user interface on the mobile computer device to enable user editing of the selected rating sticker object type, wherein said user editing includes allowing the user to move, zoom, rotate, and delete the selected rating sticker object type, and wherein the selected rating sticker object type can be configured by the user using an interface of the mobile computing to communicate a desired rating;
wherein said picture layer with inserted edited object(s) results in a composed picture;
executing the specialized software on the personal mobile computer device to provide a share interface on the mobile computer device to enable the user to select one of a plurality of options for sharing the composed picture;
providing an animation layer for providing animation functionality to one or more of the object(s) in said composed picture; and
the personal mobile computer device executing a communication function based on the selected one of the options for sharing the composed picture to share the composed picture with another computing device.

Still further provided is a method of implementing a business campaign using a personal mobile computer device customized with specialized software for distributing commentary, opinions, and/or ratings, said method comprising the steps of:
launching said business campaign on said personal mobile computing device by accepting a QR code in the device, or by accepting a passcode for activating an application that is pre-installed on the device, or by activating a URL embedded in a document displayed by the device;
providing a user with a plurality of preconfigured screens by communicating information from a server to said personal mobile computing device, wherein said plurality of preconfigured screens includes one or more question screens configured to ask the user a question, and one or more information screens configured to provide information to the user, and wherein said screens are display to the user in a predetermined order or in an order determined by a user response to one of the question screens;
using said one or more question screens to collect ratings, feedback, and/or opinions from the user pertaining to the business;
using said one or more information screens to display an advertisement or promotion, or information about a specific business campaign; and
the personal mobile computing device transmitting the collected ratings, feedback, and/or opinions from said personal mobile computing device to said server, wherein
an animation layer is provided to animate at least some of the information provided on one or more of said screens.

Also provided are additional example embodiments, some, but not all of which, are described hereinbelow in more detail.

### BRIEF DESCRIPTION OF THE DRAWINGS

The patent or application file contains at least one drawing executed in color. Copies of this patent or patent application publication with color drawings will be provided by the Office upon request and payment of the necessary fee.

The features and advantages of the example embodiments described herein will become apparent to those skilled in the art to which this disclosure relates upon reading the following description, with reference to the accompanying drawings, in which:

FIG. 1 shows a block diagram of the primary components of an example embodiment;

FIG. 2 is a screen-shot of an example initial screen of a mobile application of the example embodiment;

FIG. 3 is a screen-shot of an example start screen of the example embodiment showing social function icons;

FIG. 4 is a screen-shot of an example main screen of the example embodiment showing social function icons. FIG. 4A is a screen shot showing an example picture layer that can be edited;

FIG. 5 is a screen-shot of another example screen of the example embodiment showing additional social function icons;

FIG. 6 is a screen-shot of another example screen of the example embodiment showing example sticker icons from a sticker library. FIG. 6A is a screen shot showing ratings functions of a selected object;

FIG. 7 has a pair of a diagrams (FIGS. 7A and 7B) showing example building elements of business rating screens of the example embodiment;

FIG. 8 has diagrams showing templates for information, advertisement, and promotion screens, respectively;

FIG. 9 is a diagram showing a template for a 1-button screen;

FIG. 10 is a diagram showing a template for an A/B or 2-scale question screen;

FIG. 11 has diagrams showing example templates for 3, 4, and 5-scale questions screens, respectively;

FIG. 12 has diagrams showing example templates for Net Promoter Score questions screens;

FIG. 13 has diagrams showing example templates for percentage questions screens;

FIG. 14 has diagrams showing example templates for 5-star questions screens;

FIG. 15 has diagrams showing example templates for 10-star questions screens;

FIG. 16 has diagrams showing example templates for single and extended data screens, respectively;

FIG. 17 has a diagram showing an example template for a prize contest contact information data screen;

FIG. 18 has diagrams showing example templates for 2-picture horizontal and vertical question layout screens, respectively;

FIG. 19 has diagrams showing example templates for 3-picture horizontal and vertical question layout screens, respectively;

FIG. 20 has a diagram showing an example template for a 4-picture grid layout question screen;

FIG. 21 has diagrams showing example templates for 6-picture horizontal and vertical question layout screens, respectively;

FIG. 22 has a diagram showing an example template for a 9-picture grid layout question screen;

FIG. 23 is an example network diagram for implementing one or more example embodiments; and

FIG. 24 is a block diagram of an example user mobile device that can be used with the example embodiments.

### DETAILED DESCRIPTION OF THE EXAMPLE EMBODIMENTS

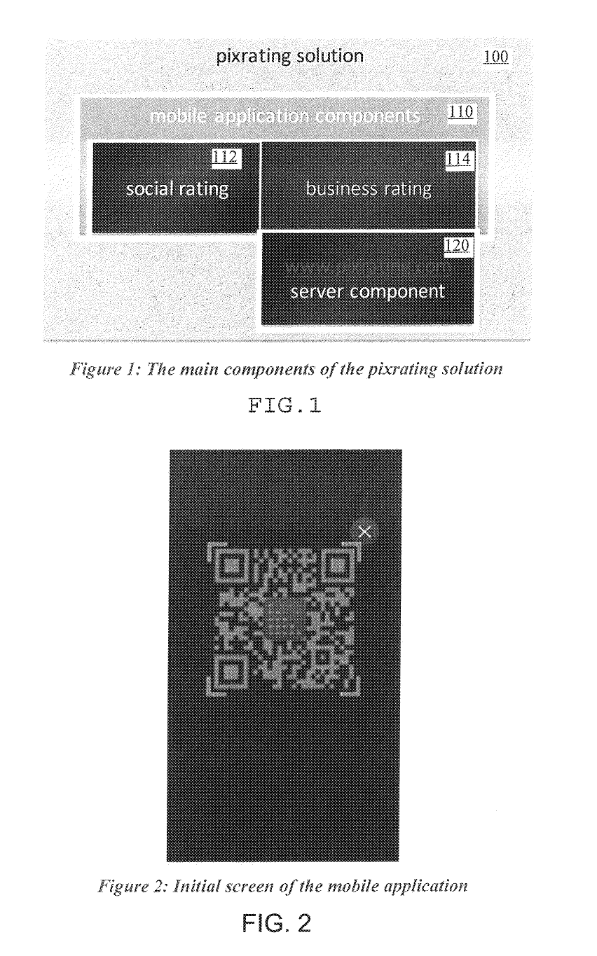

FIG. 1 shows a block diagram of an example pixrating solution 100 which is comprised of two major mobile application components as depicted in FIG. 1, which include mobile application components 110 and server component 120. The mobile application components 110 include a social rating functional set 112 and a business rating functional set 114.

The mobile application components 110 of the pixrating solution are developed for use in portable communication devices such as smartphones or tablets, for example, with which picture-based stories, snaps, emotions and ratings, feedback and opinions can be shared quickly, easily, with only a few touches. The pixrating mobile application can be implemented on all smartphone platforms including iOS, Android, and Windows Phone, for example. Client parts of the business rating components can also be run in any kind of web browser where users have the same experience of quick and easy answering to picture-, video or animation-based questions. The Example solution has two major functional sets, as described below:

(1) SOCIAL RATING: With this functional set the users can create their picture-based stories with only a few taps on the device in a simple, easy and instant way. Firstly, the user creates a picture by the camera or copy the picture from the camera roll (i.e. from the part of the internal memory of the smartphone, where the photos are stored) or from the clipboard of the smartphone (or other device). This will be the picture layer. Secondly, the picture layer can be edited (e.g., roll, zoom, pan) such as using the screen shown in FIG. 4A. The user can also put “stickers” or text objects on the picture layers, and/or can switch on labels with the creation date and place of the picture. The stickers can be pictures, drawings or predefined texts that are graphically provided. In addition, the edited picture layer, the stickers, the text objects, and the label(s) on altogether results in the composed picture, which can be saved to the camera roll, sent via email or shared to the most popular social media sites.

(2) BUSINESS RATING: This functional set collects picture-, animation- and video-based ratings, feedback, and opinions from the users by asking rating question in a campaign, meanwhile sharing information. The campaign is comprised of screens where one screen either asks one rating question or provides some information. The questions can be answered in an instant, quick, simple and easy way. In a screen the answers can be given by selecting picture(s) or providing short textual input or a rating in a scale. The functional set runs on a device, e.g., a smartphone or on a pre-installed tablet or in a browser, as the client part of a client-server architecture: campaigns are stored on the server, the functional set downloads the screens of the campaign, collects the rating answers, and sends back the user's rating results to the server.

The mobile application is freely available on the main application stores (Apple Store, Google Play, Windows Phone Store) for purchase. Any user with the access to an application store can download and install it on an appropriate device.

There are at least three different ways of involving users: the first one is when a user uses his/her own smartphone (or other device), downloads the pixrating application, starts it, and then chooses the business rating function by scanning a specific pixrating campaign QR code as it can be seen on the initial screen (see FIG. 2 showing an initial screen of the application), or they can start the social rating function by closing the QR code reader (tapping the “X” on the initial screen). The second way of involvement when pixrating is when the relevant campaigns are pre-installed on a tablet by the campaign owner, here after typing the unlocking passcode, users can choose among the listed available campaigns. The third way is running pixrating in a browser. In this case users are involved by opening a link (link can be an URL what is embedded in an e-mail or on a website or any social media site or blog or in any internet content).

The pixrating solution can be implemented in a client-server architecture. The server component 120 of the pixrating solution is developed for supporting the back-end functions of the business rating functional set. The major functions provided by the server are the follows: (1) Provide campaign purchasing, defining, managing and monitoring functions; (2) Generate QR codes or other identifiers for specific campaigns (timeframe, company, point-of-sales) and store the predefined screens of the campaigns; (3) Manage the valid campaigns: communicate with the business rating client: provides campaign screens and instructions to the client and receive rating results collected by the business rating client; (4) Provide online access to monitor the campaign data real-time; (5) Manage business users access to their campaigns; and (6) Create reports on the basis of campaign results.

The Description of the Social Rating Functional Set

This section describes the social rating functional set. Social rating design and user experience are based on two layers. The first layer is the picture layer, which can use the entire screen of the devices (smartphones, tablets, etc.) to present the current status of composed picture. The second layer is an extremely minimalist and fine design implementing all the necessary functions with animations. These functions are described in the following sections.

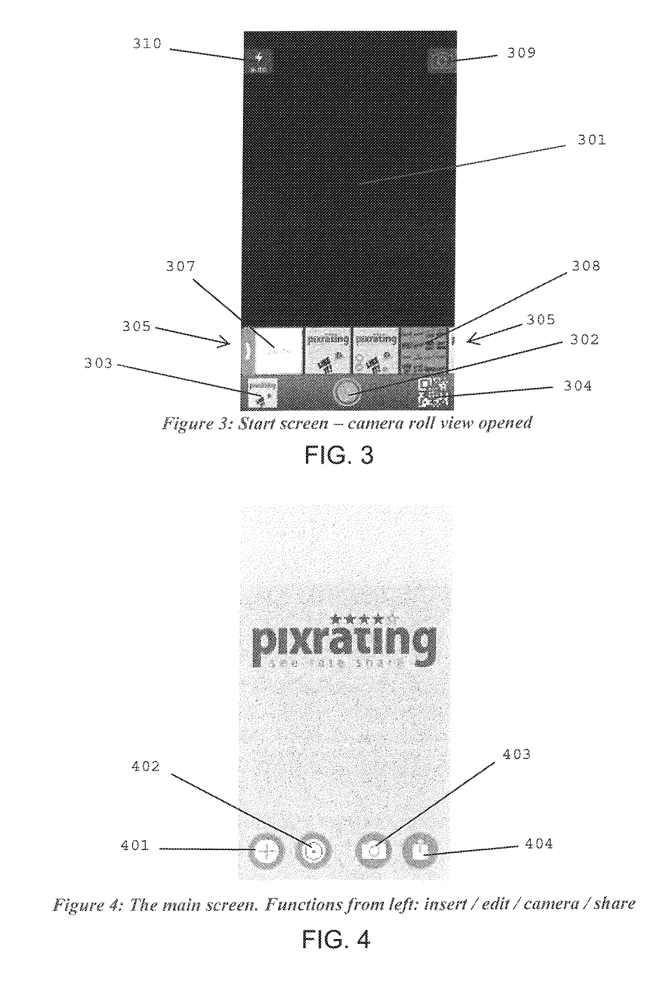

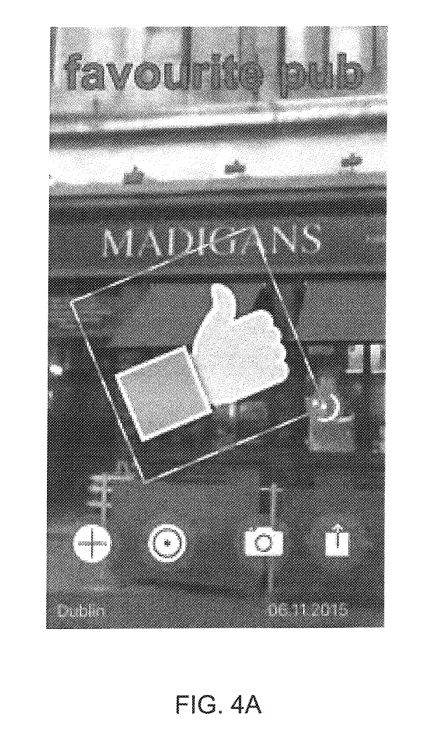

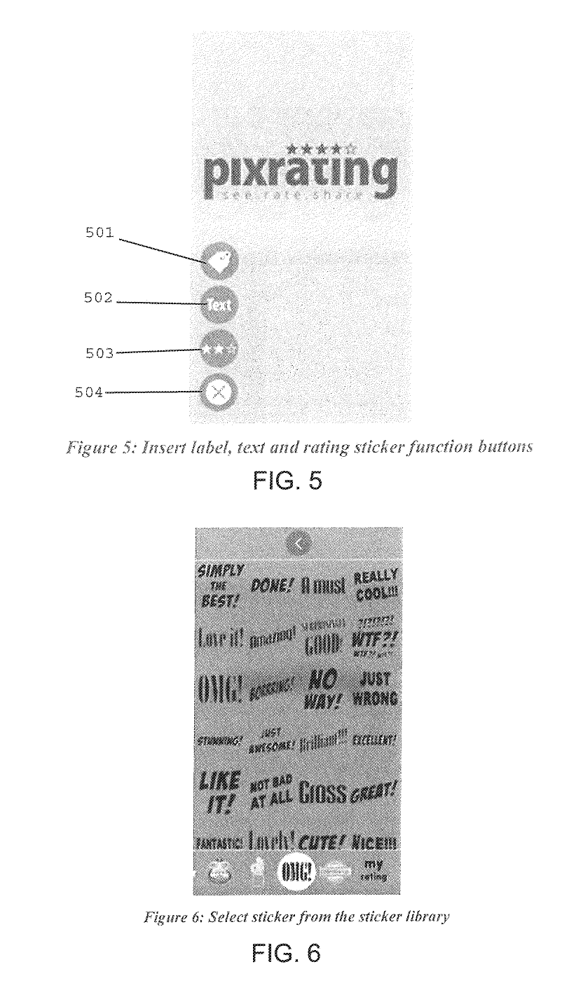

THE START SCREEN: The start screen is depicted in FIG. 3. On the start screen of the example application, the user can take a picture or select one from the camera roll (memory) or from the clipboard which will be the picture layer on the main screen.

The central area 301 of the start screen is a live camera view. By pressing the Shoot button 302 at the bottom of the screen, the application stores the current picture of the live camera view and switches to the main screen (FIG. 4).

The last from camera roll button 303 at the bottom left corner of the start screen shows the last recorded picture of the camera roll as a button. If the user taps this button, the application switches to the main screen (FIG. 4) and the last picture in the camera roll will be the picture layer. Tapping on the QR code button 304 at the bottom right corner, the user can switch back to the QR code reader function, and go to the business rating functional set.

The camera roll view 305 shows timely ordered thumbnail pictures from the camera roll. By swiping left or right on the camera roll view 305, later or earlier pictures from the camera roll are shown. By tapping on one of the thumbnail pictures 307 . . . 308 the application switches to the main screen (FIG. 4) and the selected picture in the camera roll will be the picture layer. The leftmost thumbnail picture 307 of the camera roll view 305 corresponds to the picture stored in the clipboard.

By tapping Flash settings 310, the Auto, On or Off mode for flash can be selected. By tapping the Switch camera, 309 the live camera view shows the picture of front or rear camera. This function is available only if the smartphone or tablet has both front and rear cameras.

THE OVERVIEW OF THE MAIN SCREEN: On the main screen as shown in FIG. 4, the user can further develop the picture layer, can zoom and rotate it, and can put stickers, text objects and label on it and share it. The editing area of the composed picture shows the results of the editing in WYSIWYG (“what-you-see-is-what-you-get”) mode.

By tapping an object on the picture layer, it will be selected. The selected state is indicated by a small x button as the selection indicator on the left upper corner of the button. From left to right the function related to buttons (in case of iOS platforms—on other platforms this list and order may vary): insert functions 401 (insert label, text and rating sticker); edit function: zoom and rotate the selected object 402; switch to camera function 403 returns back to the start screen (see FIG. 3); and share function 404: the composed picture can be saved or shared. These functions are discussed in more detail in the following paragraphs.

INSERT FUNCTION: Using the insert function as shown in FIG. 5, three different objects can be inserted, as follows:

(1) Switch on/off label: By tapping label button 501, the user can insert a label object into the bottom of the picture layer. The label object displays the location and time information stored for the picture layer. By tapping label button 501 while label object is on, the label object will be removed. Only one label object can be on the picture layer.

(2) Insert text: By tapping text button 502, the user can type and insert a text object into the picture layer. Moreover, while text object is selected it can be replaced anywhere on the picture layer. By tapping the text button 502 while text object is on, the text object will be removed. More text objects can be inserted into the picture layer. After selecting a text object on the main screen, it can be edited by tapping the edit button (second one from left, FIG. 4). Line colour, fill colour, font type and font size can be changed by using the provided sliding knob.

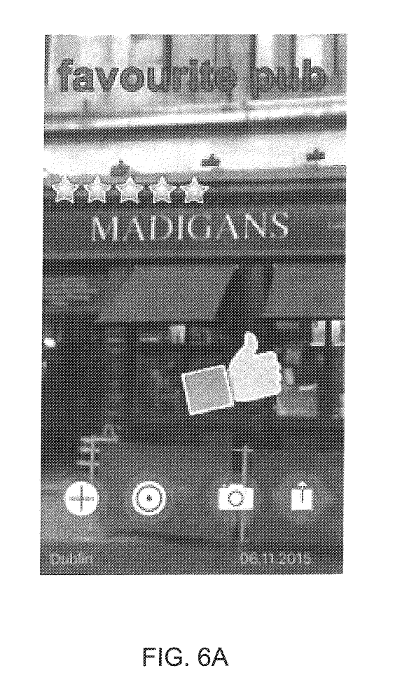

(3) Insert rating sticker: By tapping rating sticker button 503, the user can choose among the rating stickers in the sticker library (see FIG. 6) and insert a sticker into the picture layer. When a sticker is selected on the picture layer, at the bottom right corner there is provided a ‘zootate’ button, which zooms and rotates simultaneously the selected object. More rating sticker object can be inserted into the picture layer. Double tapping the rating sticker 503 allows the sticker to be changed to another sticker found in the sticker library. The window can be closed by clicking the close button 504.

EDIT AND CHANGE FUNCTIONS: Edit and change functions of a selected object are discussed in more detail in the following paragraphs and can use a screen such as shown in FIG. 6A:

Select an object: By tapping a text or a sticker on the picture layer it will be selected. The selected state is indicated by rectangle around the selected object and a small x button as a selection indicator on the left upper corner of the button. There is another indicator on the selected object's right lower corner called zoom & rotate indicator.

Move: By tapping and holding an object, it follows the user's finger. In this way, the object can be moved around on the background picture layer.

Delete an object: By tapping the selection indicator (x) at the left upper corner on a selected object, it will be deleted.

Zoom & rotate: By holding the zoom & rotate indicator of a selected object, the right lower corner of the object follows the user's finger. In this way, the object can be resized or rotated simultaneously. The selected object can be rotated and resized with the sliding knob, too. Sliding knob works with the buttons in the same way as described in the relevant previous section, i.e. editing picture layer.

Share function: By tapping the share button, the standard sharing area is activated on the lower part of the main screen. On the sharing area, the user can share the composed picture in the following ways: (a) Message; (b) e-mail; (c) Twitter, (d) Facebook, (e) Instagram and other popular social media platforms; or (f) any other application which is set on the device. The user can also save the composed picture to the camera roll, to the clipboard or it can be assigned to a contact.

The Business Rating Functional Set

This section presents the business rating functional set of the pixrating application. The business rating functional set collects ratings, feedback, and opinions from users by asking picture-, animation- and video-based questions in form of campaigns while it also shares the collected information with the entitled users in real time. Table 1 provides a list of definitions of terms used for this function.

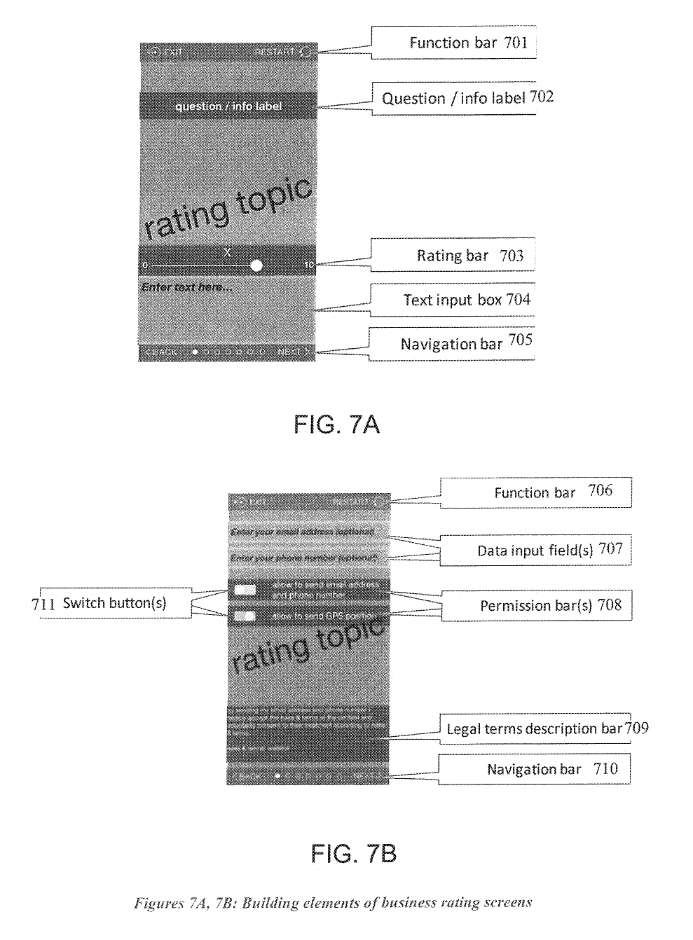

TABLE 1
Business Rating Functional Set Definitions

| Campaign: | | A campaign is a given set of screens what can be seen by users on their |
|---|---|---|
| | | mobile phones or on pre-installed tablets. A campaign can be started by |
| | | welcome and finished by goodbye screen and can include rating |
| | | questions, promotions, advertisements or other types of information. |
| | | The minimum campaign length is one screen. Theoretically campaigns |
| | | might have any reasonable length; therefore it may be comprised of any |
| | | number of screens. |
| Campaign access: | | A campaign can be accessed on a smart phone or on a pre-installed |
| | | tablet. |
| Campaign start: | | It can be triggered either by scanning a QR code or clicking on a special |
| | | link in an email or on a website or by selecting the relevant campaign |
| | | from a menu. |
| Campaign screen | | Screen types can be categorised into campaign screen categories |
| category: | | based on their roles within a campaign (e.g. information screens and 1- |
| | | button-screens can both fulfil the roles of welcome or goodbye screens). |
| First layer: | | Rating topic or multiple rating topic is the first (i.e. the lowest) layer of |
| | | the GUI (Graphical User Interface). It can be represented either by a |
| | | single Rating topic or Multiple rating topics. |
| | Rating topic: | It can be one of the followings: picture, animation, picture with sound, |
| | | animation with sound, video and augmented reality. |
| | Multiple | It can be any combination of pictures, animations and video with only |
| | rating topics: | one soundtrack, for example: FIG. 18: 2-picture horizontal and vertical |
| | | layout questions. |
| Second layer: | | The second layer may include the combination of the following objects: |
| | | Navigation bar, Function bar, Question/info label, Rating bar, Text input |
| | | box, Data input field, Permission bar, Switch button, Legal terms |
| | | description bar. |
| | Navigation | The navigation bar 705, 710, such as shown in FIGS. 7A, 7B, is one of |
| | bar: | the screen elements that is present on every business rating screen |
| | | type. It is always shown at the bottom of the screen in a fixed size. In its |
| | | left end and there is a “BACK” button (and icon), in its right end there is |
| | | a “NEXT” button (and icon) and between the two buttons there is the |
| | | Sequence indicator. |

BACK/NEXT: Jumping to the previous or next screen. By jumping to the

previously answered questions, the user is able to
change his/her previous answers. In case of question
screens, if the answer still has not been given, it is not
possible to select “NEXT”.

Sequence indicator: It contains as many circles as many screens the

entire campaign is comprised of; it indicates the
sequential number of the screen shown by filling in
the relevant circle in line while all the other circles
remain empty.

| | |
|---|---|
| Function bar: | The function bar 701, 706 is one of the screen elements that is present |
| | on every business rating screen type, such as shown in FIGS. 7A, 7B. |
| | It is always shown at the top of the screen in a fixed size. In its left end |
| | and there is an EXIT button (and icon) while in its right end there is a |
| | RESTART button (and icon). |
| | EXIT: Brings back the user to the beginning of the campaign: |

If the campaign is run on smart phone (initiated by QR code)
the EXIT button leads back to the initial screen of the mobile
application (see FIG. 2: Initial screen of the mobile
application);
In case of campaigns run on pre-installed devices the EXIT
button brings back the user to the Initial (PIN entering)
screen of the tablet version.

| | RESTART: Back to the welcome screen by resetting all the answer |
|---|---|
| | given so far. |
| Question/info | The question/info label 702, such as shown in FIG. 7A, provides a |
| label: | brief description of the question or the information that the given screen |
| | aims to ask from or communicate towards the user (depending on the |
| | type of the screen). |
| Rating bar: | The rating bar 703, such as shown in FIG. 7A, is a screen element |
| | where the user can provide his/her answer to the given question. The |
| | concrete content and structure of the Rating bar vary depending on the |
| | question type represented by the screen (e.g. five-star, yes-no, 2-3-4-5 |
| | scale, NPS scale, % scale). Optionally can be supplemented with text |
| | input box. |
| Text input | The text input box 704, such as shown in FIG. 7A, is an optional |
| box: | complementary element to the Rating bar in case of question types |
| | where it fits into the concept to ask supplementary information from the |
| | user besides the provided rating (for details see description of Question |
| | types). It is a free text field. |
| Data input | The data input field 707, such as shown in FIG. 7B, is a field to |
| field: | request (personal) information (e.g. e-mail address, phone number, |
| | loyalty card ID or any other information) from the user. Can request free |
| | text input or can offer a drop down list from which the user can select |
| | the relevant answer. |
| Permission | The permission bar 708, such as shown in FIG. 7B, contains |
| bar: | description of the activity (e.g. “Allow to send GPS position” or “Allow to |
| | send e-mail address and phone number”) that can be either allowed or |
| | disabled by the user by putting the Switch button (next to the Permission |
| | bar) into the requested position. |
| Switch | A two-position (toggle) switch 711, such as shown in FIG. 7B, by |
| button: | which the user can either allow or disable a certain activity (e.g. “Allow |
| | to send GPS position” or “Allow to send e-mail address and phone |
| | number”) described in the Permission bar, next to the Switch button. |
| | The position of the switch can be changed by the user by tapping on it |
| | or by sliding his/her finger from one side of the switch to the other one. |
| Legal terms | A legal terms description bar 709, such as shown in FIG. 7B, is fixed |
| description | element of the “Data screen for prize contest contact info” containing a |
| bar: | standard legal text which is compulsory to be shared with the user when |
| | asking for personal data from him/her. |

| | |
|---|---|
| Animation: | Movement of the screen elements to further improve the visual |
| | experience. Some pixrating animations are e.g.: |

When arriving to a new screen, the elements of the Second layer
(Question/info label, Rating bar etc.) fly in from the right and
“bounce” softly before taking their final place on the screen;
Buttons in the Rating bar are pulsating to attract the user's attention;
Selected button(s) in the Rating bar become(s) larger while (if the
button contains text) the font size increases as well;
In case of question, information, advertisement and promotion
screens where the First layer is comprised of a single Rating topic,
when the user slides his/her finger on the Rating topic or taps on the
Rating topic then the Second layer disappears towards the top
(Function bar and Question/info label) and the bottom (Navigation
bar, Rating bar and Text input box) and only the Rating topic can be
seen. After a few seconds the elements of the Second layer re-
appear from the direction where they disappeared previously.
In case of certain screen types, a moving timeline (above the
Navigation bar) shows the time length of the picture shown/video/
animation etc.
When leaving a screen, the elements of the Second layer (Question/
info label, Rating bar etc.) fly out towards the left.

List of animation types are used within pixrating solution is expanding
due to the continuously improved User Experience (UX).

Screen types: The available screen types and their layouts within the common presentation frame are described in the following paragraphs.

QUESTION TYPES: The following questions types are supported by the example embodiment:

A/B or 2-scale question: The user can choose one out of two options by tapping Picture A or B. This screen type is comprised of a Rating topic, the Navigation bar and the Function bar, a Question/info label and a Rating bar (comprising two buttons). See FIG. 10: A/B or 2-scale question.

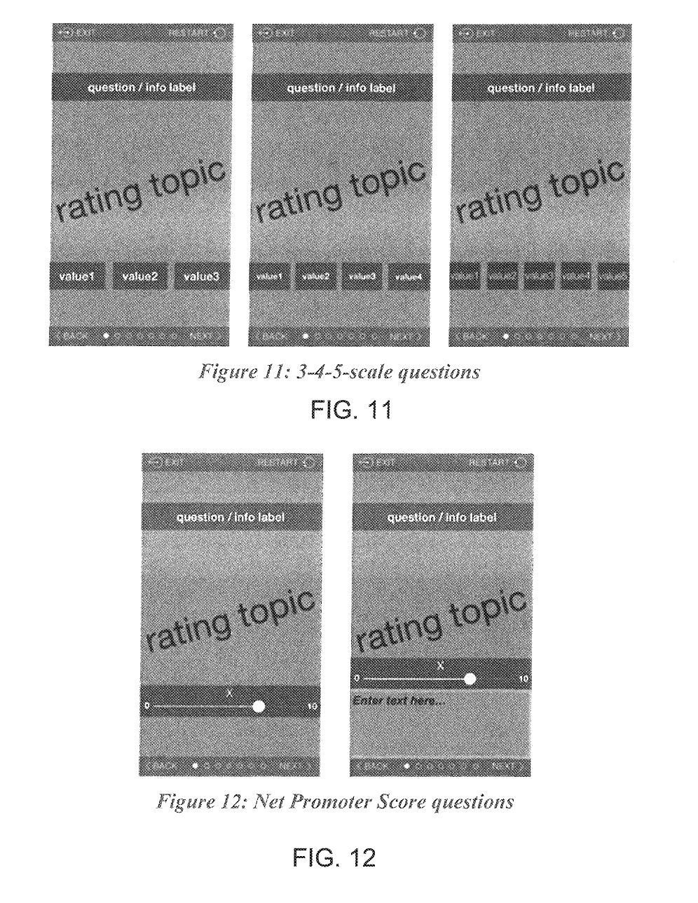

3-4-5-scale questions: This question type presents multiple (three, four or five) potential choices as answers. This screen type is comprised of a Rating topic, the Navigation bar and the Function bar, a Question/info label and a Rating bar (comprising three, four or five buttons). Buttons can be represented by rectangles (or other shapes) with texts on them or by other figures (e.g.: small animal, medium-sized animal, and large animal; or four glasses of wine filled up to different levels etc.). See FIG. 11: 3-4-5-scale questions.

Net Promoter Score (NPS) questions: NPS is a Key Performance Indicator (KPI) used by several companies. It is calculated based on responses to a single question: “How likely is it that you would recommend our company/product/service to a friend or colleague?” The scoring for this answer is based on a 0 to 10 scale. Pixrating enables companies to collect NPS information directly from the customers in a very simple way, by tapping and sliding the rating bar between the values 0 and 10. This screen type is comprised of a Rating topic, the Navigation bar and the Function bar, a Question/info label and a Rating bar (comprising a slider on which the user can select integer values between 0 and 10) and can optionally contain a Text input box. See FIG. 12: Net Promoter Score questions.

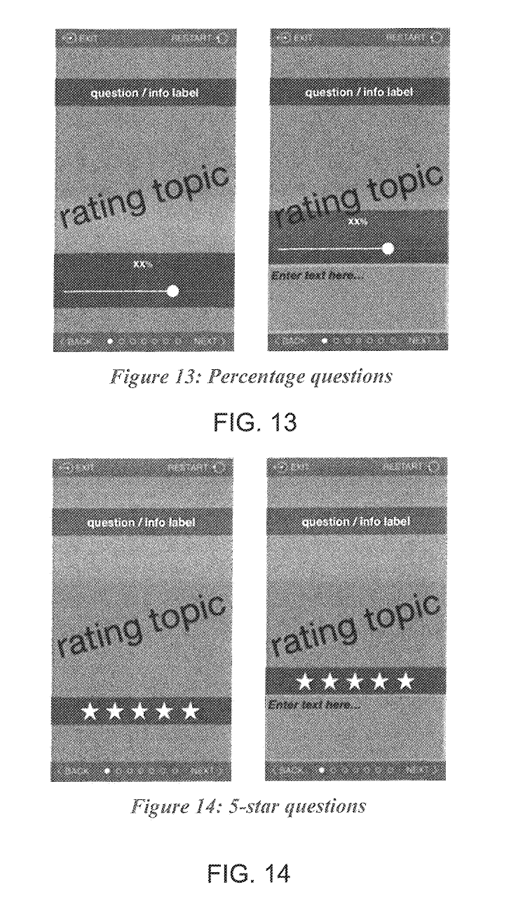

Percentage questions: The user can provide any (integer) value between 0% and 100% as answer to the given question by tapping and sliding the rating bar between the end values. This screen type is comprised of a Rating topic, the Navigation bar and the Function bar, a Question/info label and a Rating bar (comprising a slider on which the user can select integer values between 0% and 100%) and can optionally contain a Text input box. See FIG. 13: Percentage questions.

5-star questions: The user can give a rating by selecting a value between one to five stars. Stars can be selected either by sliding the user's finger on the Rating bar (containing five stars) or by tapping on the star that in the sequence represents the value that the user wants to provide as feedback (e.g. if the user wants to give four stars as feedback he/she can do it by sliding his/her finger from the left until the fourth star or by tapping on the fourth star from the left on the Rating bar). This screen type is comprised of a Rating topic, the Navigation bar and the Function bar, a Question/info label and a Rating bar (comprising five stars) and can optionally contain a Text input box. See FIG. 14: 5-star questions.

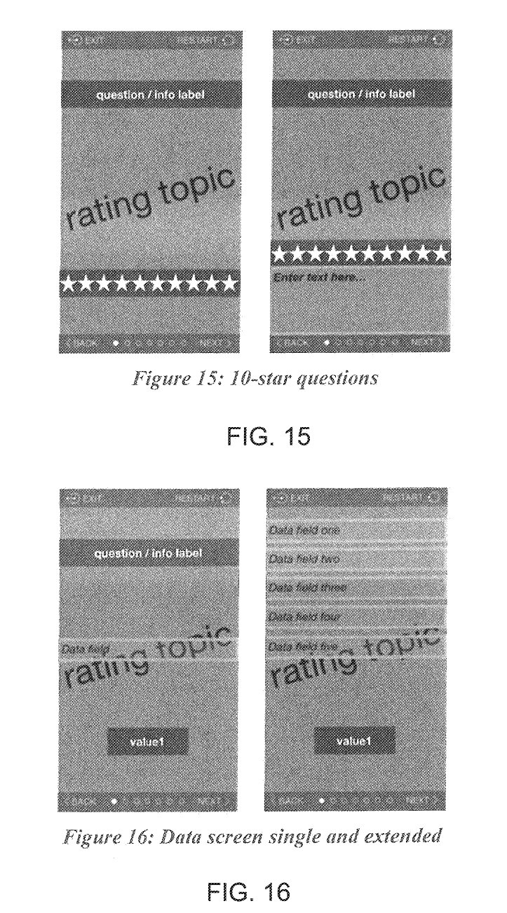

10-star questions: The user can give a rating by selecting a value between one to ten stars. Stars can be selected either by sliding the user's finger on the Rating bar (containing ten stars) or by tapping on the star that in the sequence represents the value that the user wants to provide as feedback (e.g. if the user wants to give four stars as feedback he/she can do it by sliding his/her finger from the left until the fourth star or by tapping on the fourth star from the left on the Rating bar). This screen type is comprised of a Rating topic, the Navigation bar and the Function bar, a Question/info label and a Rating bar (comprising ten stars) and can optionally contain a Text input box. See FIG. 15: 10-star questions.

2-picture horizontal and vertical layout questions: The user can choose between two rating topics (pictures, animations or videos) by tapping on the one he/she wants to select. This screen type is comprised of Multiple rating topics (two rating topics, either in horizontal or in vertical sequence), the Navigation bar and the Function bar. See FIG. 18: 2-picture horizontal and vertical layout questions.

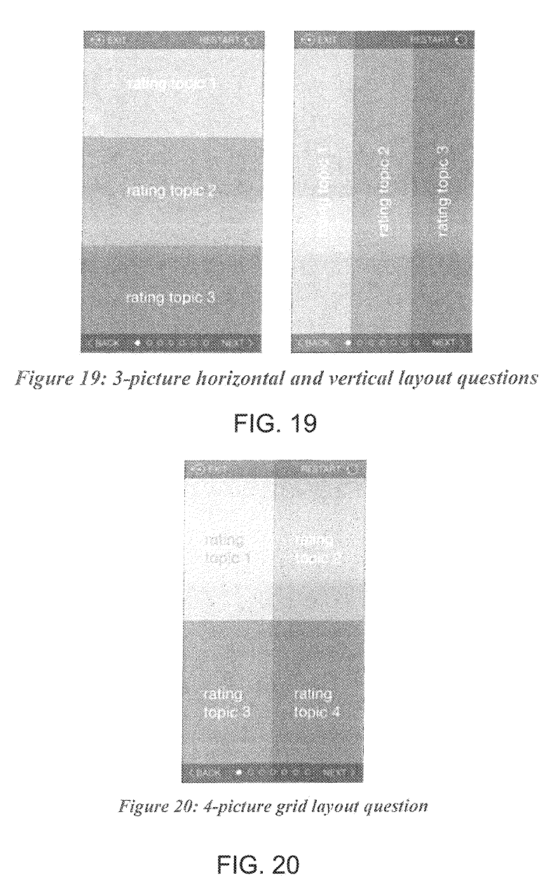

3-picture horizontal and vertical layout questions: The user can choose between three rating topics (pictures, animations or videos) by tapping on the one(s) he/she wants to select. The requested answer can be single-choice (i.e. only one picture can be selected as answer) or multiple-choice (i.e. more answers can be selected from the alternatives by tapping on the relevant pictures). This screen type is comprised of Multiple rating topics (three rating topics, either in horizontal or in vertical sequence), the Navigation bar and the Function bar. See FIG. 19: 3-picture horizontal and vertical layout questions.

4-picture grid layout question: The user can choose between four rating topics (pictures, animations or videos) by tapping on the one(s) he/she wants to select. The requested answer can be single-choice (i.e. only one picture can be selected as answer) or multiple-choice (i.e. more answers can be selected from the alternatives by tapping on the relevant pictures). This screen type is comprised of Multiple rating topics (four rating topics arranged in form of 2×2 matrix), the Navigation bar and the Function bar. See FIG. 20: 4-picture grid layout question.

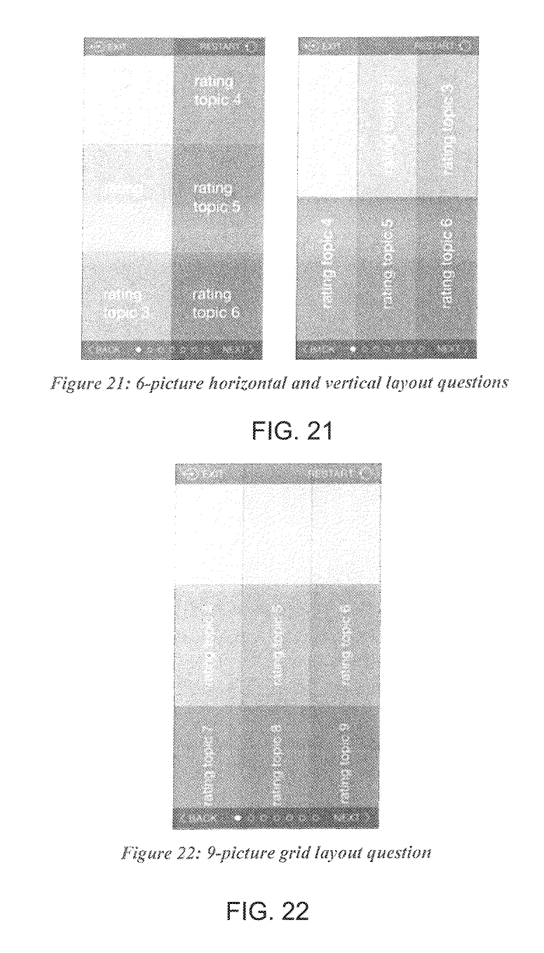

6-picture horizontal and vertical layout questions: The user can choose between six rating topics (pictures, animations or videos) by tapping on the one(s) he/she wants to select. The requested answer can be single-choice (i.e. only one picture can be selected as answer) or multiple-choice (i.e. more answers can be selected from the alternatives by tapping on the relevant pictures). This screen type is comprised of Multiple rating topics (six rating topics arranged in form of 2×3 or 3×2 matrix, vertically or horizontally), the Navigation bar and the Function bar. See FIG. 21: 6-picture horizontal and vertical layout questions.

9-picture grid layout question: The user can choose between nine rating topics (pictures, animations or videos) by tapping on the one(s) he/she wants to select. The requested answer can be single-choice (i.e. only one picture can be selected as answer) or multiple-choice (i.e. more answers can be selected from the alternatives by tapping on the relevant pictures). This screen type is comprised of Multiple rating topics (nine rating topics arranged in form of 3×3 matrix), the Navigation bar and the Function bar. See FIG. 22: 9-picture grid layout question.

Large-grid layout question: Contains a matrix of multiple rating topics where the whole set of pictures is larger than the size of the screen. The user can view and select the rating topics by scrolling on the screen vertically and/or horizontally. The user can choose between the rating topics (pictures, animations or videos) by tapping on the one(s) he/she wants to select. The requested answer can be single-choice (i.e. only one picture can be selected as answer) or multiple-choice (i.e. more answers can be selected from the alternatives by tapping on the relevant pictures). This screen type is comprised of Multiple rating topics, the Navigation bar and the Function bar.

DATA INPUT SCREEN TYPES: the following paragraphs describe data input screen types:

Data screen single: With this screen type the user can be asked to provide one data (e.g. e-mail address, phone number, loyalty card ID or any other information) and approve it with the button in the Rating bar. To provide personal information is always optional. This screen type is comprised of a Rating topic, the Navigation bar and the Function bar, (optionally) a Question/info label, a Rating bar (comprising one button) and one Data field (can request free text input or provide drop down list). See FIG. 16: Data screen single and extended.

Data screen extended: With this screen type the user can be asked to provide more pieces of data (e.g. e-mail address, phone number, loyalty card ID or any other information) and approve them with the button in the Rating bar. To provide personal information is always optional. This screen type is comprised of a Rating topic, the Navigation bar and the Function bar, a Rating bar (comprising one button) and multiple Data fields (they can request free text input or provide drop down list). See FIG. 16: Data screen single and extended.

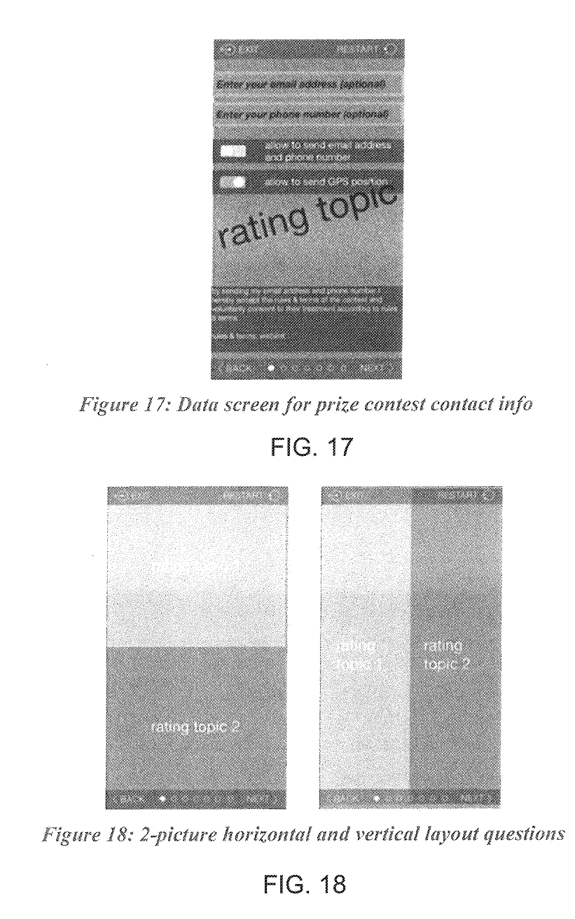

Data screen for prize contest contact info: With this screen type the user can be asked to provide contact information (e.g. e-mail address, phone number) to participate in a prize contest organised within the campaign. To provide personal information is always optional. The user can also allow or not allow the application to send his/her personal data (e.g. e-mail address, phone number, GPS position) to the campaign owner (i.e. to the server) by tapping on the switch button(s) next to the permission bar(s). To meet legal requirements, the screen also contains a legal text about the implicit acceptance of the rules & terms of the contest by sending personal data to the campaign owner. This screen type is comprised of a Rating topic, the Navigation bar and the Function bar, multiple Data fields (can request free text input or provide drop down list), one or more Permission bar(s) with Switch button(s) next to them and a Legal terms description bar. See FIG. 17: Data screen for prize contest contact info.

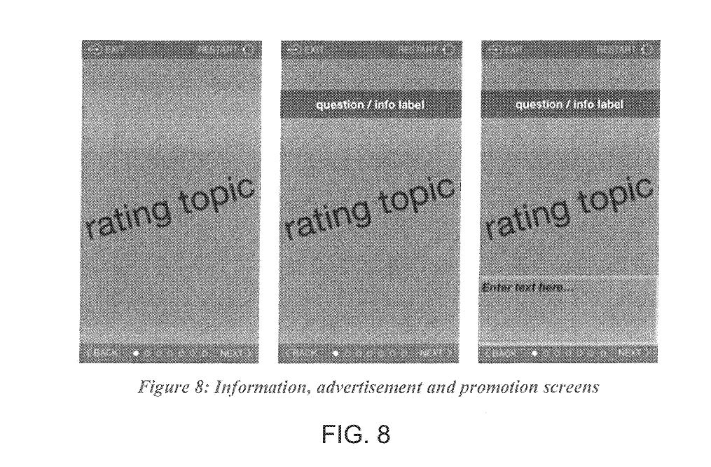

Information, advertisement and promotion screen type: This screen type allows the campaign owner company to communicate any information, advertisement or promotion towards the user. It is comprised of a Rating topic, the Navigation bar and the Function bar and can optionally contain a Question/info label and a Text input box. See FIG. 8: Information, advertisement and promotion screens.

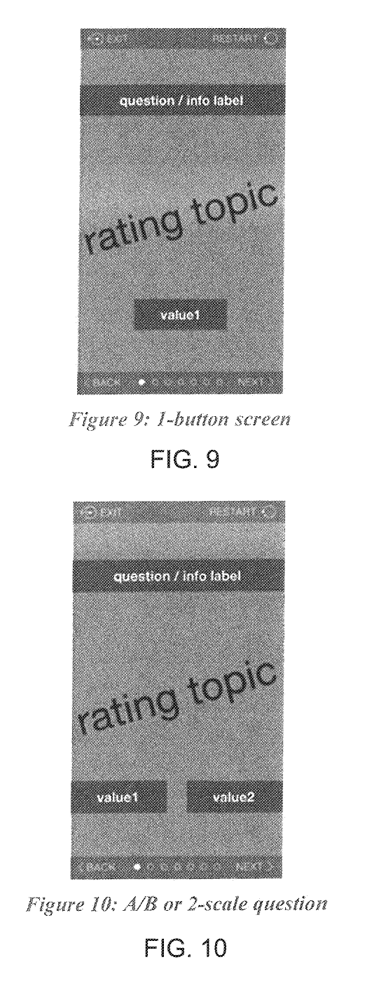

1-button screen: With this screen type information can be provided to the user who can tap on the one single button on the screen if he/she wants. This screen type is comprised of a Rating topic, the Navigation bar and the Function bar, a Question/info label and a Rating bar (comprising one button). See FIG. 9: 1-button screen.

The Campaign

A campaign is a given set of screens what can be seen by users on their mobile phones or on pre-installed tablets or in their web browsers of any kind on any kind of device. A campaign can be started by welcome and finished by goodbye screen and can include rating questions, promotions, advertisements or other types of information. The minimum campaign length is one screen. Theoretically campaigns might have any reasonable length; therefore it may be comprised of any number of screens.

A campaign can be triggered either by scanning a QR code or clicking on a special link in an email or on a website or by selecting the relevant campaign from a menu.

In the basic case, the screens are shown to the user one after the other, i.e. the order of screen is 1, 2, 3 . . . n, where n is the number of the screens in a campaign. However, there is an option for more interactive operation. This feature is called dependent questioning. If it is active, the next question to be asked depends on the answer or answers given previously.

Screen types can be categorized into following campaign screen categories based on their roles within a campaign:

Welcome screen: Starting screen of a campaign.

Question screen: The most important screen category within all campaigns. A question screen represents a question that can be raised for different purposes, e.g.: (a) for quality feedback; (b) to ask about customer's preferences (which one(s) he/she would choose from different options); (c) whether and how much customer would recommend your services or product; (d) about personal information for segmentation (gender, age etc.); and (e) to provide his/her opinion on a question or vote for a given option (where answer proportions can be published in a public space to mobilize community, e.g. football stadium, bar or conference). The potential answers for the question can be symbolized by pictures, scales and/or text boxes. A question screen can also contain additional explanatory text and input field for user's comment or textual or even picturized answer. By selecting one or more pictures on the question screen or answer in a scale or providing textual input, the user gives his or her choice or choices. There are more alternatives to ask a question. These options are referred as question types, they are the potential combinations and layouts for the pictures, symbols, scales, texts on a given question screen. The detailed descriptions of question types are given above.

Information/advertisement/promotion screen: This screen can include one of three screens: (a) Information screen: The information screen provides information to the user which can be several different things, for example information about the whole campaign, a welcome or a goodbye message, instruction to the way of answering, information about the organization asking questions, a further link etc.; (b) Advertisement screen: Screens can be used for advertising a relevant product or service, which can be either by the campaign owner company's or also a third party's; and/or (c) Promotion screen: Screens can be used for introducing a promotion, which can be either by the campaign owner company's or also a third party's.

Gamification/prize contest promoting screen: A prize contest or other gamification element attached to a campaign can be an important motivation for users to provide answers which allows them to participate in the game. On the Gamification/prize contest promoting screen this motivational game can be promoted to the user, mainly in form of a picture.

Data input screen: This screen can be used for collecting one or more personal information items from the user, e.g. name, phone number, email address, postal address, loyalty card ID, discount coupon ID etc. To provide personal information is always optional. The information collected in this way is also sent to the server (like other provided answers within the campaign) and can be processed there.

Voucher screen: It can contain any types of picture-based vouchers: promotion code, bar code, QR code etc.

Goodbye screen: Closing screen of a campaign that can be used for closing the interaction with the user.

At least one question screen is needed in every campaign. All other campaign screen categories are optional to include in a campaign. The following Table 2 illustrates the connection between the campaign screen categories and the (previously defined) screen types:

TABLE 2

| | Applicable screen types | | | | | | | | |
|---|---|---|---|---|---|---|---|---|---|
| | | | | | | | | | All 2-picture, |
| | | | | | | | | Data screen | 3-picture, 4- |
| | Information, | | | | | | | single/ | picture, 6 |
| | advertisement | | | From 3- | | | | extended/ | picture and 9- |
| Campaign | and | 1- | A/B or 2- | scale to 10- | | | Five- and | for prize | picture |
| screen | promotion | button | scale | scale | NPS | % | Ten-star | contest | layout |
| categories | screen | screen | question | question | question | question | questions | contact info | questions |
| Welcome | X | X | | | | | | | |
| screen | | | | | | | | | |
| Question | | | X | X | X | X | X | | X |
| screen | | | | | | | | | |
| Info/ | X | X | | | | | | | |
| advertisement/ | | | | | | | | | |
| promotion | | | | | | | | | |
| screen | | | | | | | | | |
| Gamification/ | X | X | | | | | | | |
| prize | | | | | | | | | |
| contest | | | | | | | | | |
| promoting | | | | | | | | | |
| screen | | | | | | | | | |
| Data input | | | | | | | | X | |
| screen | | | | | | | | | |
| Segmentation | | | X | X | | | | X | X |
| screen | | | | | | | | | |
| Voucher | X | X | | | | | | | |
| screen | | | | | | | | | |
| Goodbye | X | X | | | | | | | |
| screen | | | | | | | | | |

Representations of Campaign Results

Campaign results can be displayed in different ways, e.g.: (a) campaign owners have real-time access and monitor campaign results at pixrating.com with their own dedicated user account; (b) campaign owners can define any relevant website or social media site to publish the real-time campaign results or the summary report of the campaign results; (c) customisable daily, weekly or monthly reports can be generated and can be sent to the campaign owners; (d) campaign results can be published on public screens (e.g. football stadium, bar or conference), web sites or social media sites; (e) campaign results can be sent automatically in an e-mail after an event (trainings, workshops, webinars); and (f) relevant campaign results and the number of ratings can be displayed on the smartphone of the dedicated customer. Way(s) of campaign result representation should be aligned with business goals.

A campaign lifecycle may be comprised of following main phases: (1) Campaign definition (from business perspective); (2) Campaign preparation (from technical and infrastructure perspective); (3) Campaign execution; (4) Data summary and representation; (5) Data analysis; and (6) Follow-up. Tasks related to a campaign are divided between pixrating and the partner company, depending on the level of customisation and the given cooperation terms.

Example Client-Server Operation of the Pixrating

The social rating functional set of pixrating solution is a fully stand-alone tool, usable without any server connections. The business rating functional set is implemented as the client side of a client-server architecture. The business rating of pixrating, however, requires a server, which prepares, transfers and manages the campaign data for the client and collect data from it.

The information to be shared and questions to be asked is derived from a business need. The information and the business level questions are translated to a campaign using the different screen types written above. The definitions of the campaign are stored on a server connected to the internet. Different campaigns emerge from different business needs and any number companies can be stored on the server where each campaign has a unique identifier.

As the first step of the client-server iteration the client sends to the server the identifier of the campaign to be downloaded. The identifier is based on input data and the user can provide it in the following ways:

Scanning a QR-code or unique visually designed codes: The question sequence identifier is encoded in a QR-code. The user scans the printed QR-code. The application decodes the identifier from the scanned QR-code then sends it to server, then downloads and starts presenting the appropriate campaign.

Pre-installed tablet: After selecting the relevant campaign, the communication between the client and the server is the same as it is written for the QR code.

Email link or web link or link in any social media or internet content: using a smartphone or a tablet or desktop computer by clicking on an appropriate link, generated by pixrating, the pixrating application starts and decodes the identifier, then sends it to server, then downloads and starts presenting the appropriate campaign.

NFC chip: The identifier of the question sequence can be read by holding user's mobile phone close enough to an NFC chip. After reading and recognizing the NFC chip, the following steps (i.e. decoding the identifier stored on the NFC chip, communication to the server, managing the question sequence and sending answers back to the server) are the same as it is described for the QR code.

The client side interacts with the server via internet connection in the following ways: (1) The client application sends a campaign identifier to the server; (2) The relevant campaign is downloaded from the server to the client, (3) The client application presents the downloaded campaign to the user and manages the collection of the rating answers. (4) All the rating answers and typed text or data provided by the user (including the optionally given personal and location information) are sent back to the server.

The main functions of the server include: (1) Create, manage and store data and pictures of company users, companies, point-of-sales and related campaigns; (2) Generate QR codes for campaigns; (3) It serves the request of clients to download the campaign after identification; (4) Multiple device support (specific images depend on different device screen resolutions); (5) Receive and store the answers for campaigns; (6) Provide on-line access to contracted partners via pixrating.com in order to be able to monitor real-time way the campaign data and all the collected rating answers for campaigns; and (7) Create, customise and purchase individual campaigns.

Another function of the sever is to process the collected answers for campaigns, including: (a) generate summary and statistics reports about all the answers sent back; (b) report about the respondents' location; (c) export answers to CSV or Excel format; (d) show geographical distribution of the answers on a map; (e).

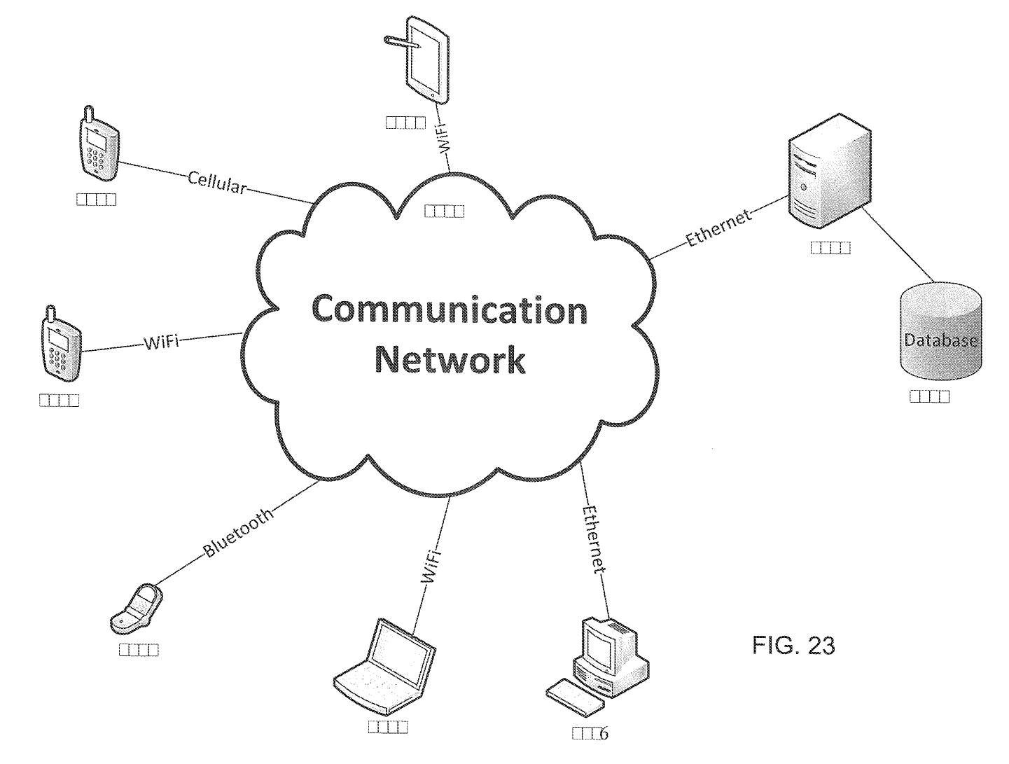

FIG. 23 shows an example network design that could be used for implementing a system as described herein. A server 1110 is connected to a database 1112 for storing the various apps for transmittal to the various external devices 1121-1126. The server may be an app storefront, or it may be accessible via a storefront that is part of the communication network cloud 1100, which may include the Internet, cellular networks, WiFi networks, and Bluetooth networks, among others. The external devices include, among others, tablets 1121, smartphones 1122, 1123, cell phones 1124, laptops 1125, and personal computers 1126, any of which may connect to the server via a communication network 1000 (e.g., the Internet) via various means, such as cellular networks, WiFi, Ethernet, Bluetooth, among others.

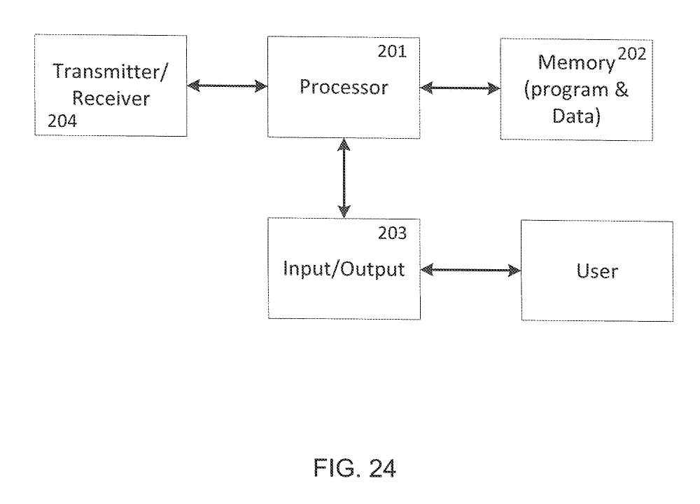

FIG. 24 shows a simplified view of an example external device, most of which will include at least one processor 201 connected to at least one memory 202 which stores programs for execution and data. The processor is also connected to one or more input/output components 203, such as displays, touchscreens, input keys, speakers, microphones, etc. for inputting data and information into the processor 201 and displaying data, graphics, sounds, etc. to a user of the device. Most devices will have one or more a transmitter/receiver 204, which can include any of a number of networking interfaces for connecting to computer or other communications networks (e.g., WiFi, Ethernet, cellular), and/or connecting to other devices (e.g., Bluetooth, USB).

As will be appreciated by one of skill in the art, the example embodiments may be actualized as, or may generally utilize, a method, system, computer program product, or a combination of the foregoing. Accordingly, any of the embodiments may take the form of an entirely hardware embodiment, an entirely software embodiment (including firmware, resident software, microcode, etc.) for execution on hardware, or an embodiment combining software and hardware aspects that may generally be referred to as a “system.” Generally, the “system” will comprise a server with storage capability such as one or more databases that interact with a plurality of remote devices via a communication network such as the Internet, an intranet, or another communication network such as a cellular network. The remote devices include any of a plurality of computing devices, such as smart phones, phablets, tablets, or personal computers, for example. The remote devices will execute software (one or more “apps”) that has been downloaded from the server to each of the remote devices to perform the functions described herein.

Furthermore, any of the embodiments may take the form of a computer program product on a computer-usable storage medium having computer-usable program code embodied in the medium.

Any suitable computer usable (computer readable) medium may be utilized for storing the software. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CDROM), cloud storage (remote storage, perhaps as a service), or other tangible optical or magnetic storage device; or transmission media such as those supporting the Internet or an intranet.

Computer program code for carrying out operations of the example embodiments (e.g., for the aps or server software) may be written by conventional means using any computer language, including but not limited to, an interpreted or event driven language such as BASIC, Lisp, VBA, or VBScript, or a GUI embodiment such as visual basic, a compiled programming language such as FORTRAN, COBOL, or Pascal, an object oriented, scripted or unscripted programming language such as Java, JavaScript, Perl, Smalltalk, C++, Object Pascal, or the like, artificial intelligence languages such as Prolog, a real-time embedded language such as Ada, or even more direct or simplified programming using ladder logic, an Assembler language, or directly programming using an appropriate machine language. Web-based languages such as HTML or any of its many variants may be utilized. Graphical objects may be stored using any graphical storage or compression format, such as bitmap, vector, metafile, scene, animation, multimedia, hypertext and hypermedia, VRML, and other formats could be used. Audio storage could utilize any of many different types of audio and video files, such as WAV, AVI, MPEG, MP3, MP4, WMA, FLAC, MOV, among others. Editing tools for any of these languages and/or formats can be used to create the software.

The computer program instructions of the software and/or scripts may be provided to a computing device (e.g., a smartphone, tablet, phablet, PC or other device) which includes one or more programmable processors or controllers, or other programmable data processing apparatus, which executes the instructions via the processor of the computer or other programmable data processing apparatus for implementing the functions/acts specified in this document. It should also be noted that, in some alternative implementations, the functions may occur out of the order noted herein.
In the example Pixrating solution:
The social rating and business rating functional sets are implemented in one binary program file—this program file can be downloaded from the application stores,
The business rating solution can be reached via a 3^{rd} party provider; therefore it is corporate independent solution without corporate brand.
The solution can be inserted as a campaign engine into other company specific mobile or web-based solution.
The most part of the user interface can be used with one thumb or one-click movements only (except typing text),
The mobile application is identified with the app logo (in different colours) and the pixrating solution is identified with the logo type (in different colours).

Also, provided is a Social rating functional set with the characteristics that:
The functional set has a unique one-thumb-operation user interface.
Picture-based user stories can be created quickly and can be shared immediately on main social media platforms.
Scalable rating sticker: not only its size can be changed, but the number of its constituents and their attributes.
The objects (scalable rating sticker, simple rating sticker, label, text or a tag) can be added to a picture any time, no predefined mandatory order.
The objects (scalable rating sticker, simple rating sticker, label, text or a tag) are placed on different layers so any of them can be moved, deleted, enlarged at any time. They are not pasted to the picture before sharing it.
Also provided is a Business rating functional set in which:
All the design and structure of question screens described in this document especially presented from FIG. 8 to FIG. 22.
User registration is not obligatory.
The business rating solution is available through smartphones or pre-installed tablets or desktop computers.
A campaign can be started by scanning QR code or other visualised code, recognising NFC chip, opening e-mail link or web link, moreover it can be started by selecting a campaign on a pre-installed tablet.
The interaction with the user is managed mainly on picture-, animation-, picture with sound-, animation with sound-, video- and augmented reality-based campaign screens,
Business rating design and user experience based on two layers. First one is the rating topic or multiple rating topic uses the whole screen of the devices (smartphones, tablets) to present the relevant content. The second layer is an extremely minimalist and fine design implementing all the necessary functions through animations.
The campaign can be defined in a creative way, which is supported by wide range of available campaign screen types and question types.
Finally, in the Pixrating client-server implementation:
The server can store multiple campaign definitions,
Multiple campaigns can be asked in parallel,
It is a very quick process to organize a campaign, when a campaign is presented to large number of users having internet connected smartphone,
The users' answers and their location information can be summarized, processed and presented in real time,
The solution can be bought as a service.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of editing photographs using a personal mobile computer device customized with specialized software for distributing commentary, opinions, and/or ratings, the method comprising the steps of:
displaying a photograph on a display of the mobile computer device to provide a picture layer for editing;
executing the specialized software on the personal mobile computer device to provide photograph editing tools via a user interface on the mobile computer device to allow the user to edit the photograph picture layer;
executing the specialized software on the personal mobile computer device to provide an object insert user interface on the mobile computer device to enable the user to select one of a plurality of different object types for adding to the picture layer, wherein each one of the plurality of different object types are configured to communicate an opinion or rating;
executing the specialized software on the personal mobile computer device to provide an object edit user interface on the mobile computer device to enable the user to edit the selected one of the plurality of different object types, wherein
said picture layer with inserted edited objects results in a composed picture;
executing the specialized software on the personal mobile computer device to provide a share interface on the mobile computer device to enable the user to select one of a plurality of options for sharing the composed picture; and
the personal mobile computer device executing a communication function based on the selected one of the options for sharing the composed picture to share the composed picture with another computing device.

2. The method of claim 1, wherein said personalized computer device is a smart phone.

3. The method of claim 1, wherein said plurality of object types includes: a text object type configured to accept textual information, a label object type configured to display location and time information, and a rating sticker object type configured to use graphical objects to display a desired rating.

4. The method of claim 3, wherein said rating sticker object type is selected from a library of rating sticker object types each using different types of graphical objects.

5. The method of claim 1, wherein said plurality of object types includes a rating sticker object type configured to use graphical objects to display a desired rating, and wherein said rating sticker object type is selected from a library of rating sticker object types each using different types of graphical objects.

6. The method of claim 1, wherein said composed picture also includes an animation layer for providing animation functionality to the object(s) in said composed picture.

7. The method of claim 1, wherein said picture layer is configured in a grid adapted to impose one or more restrictions on the objects that can be inserted into said picture layer.

8. The method of claim 1, wherein said method is provided as part of a campaign associated with a business to include information related to a product or service.

9. The method of claim 8, wherein said method includes a step of providing the business with market information collected from the user of the personal mobile computing device regarding the product or service, wherein said market information is collected via the user executing the method using the personal mobile computing device.

10. A method of implementing a business campaign comprising the steps of claim 1, further comprising the steps of:
providing a user with a plurality of preconfigured screens by communicating information from a server to said personal mobile computing device, wherein each one of said screens is configured to either ask the user a question, or provide information to the user; and
using said plurality of preconfigured screens to collect ratings, feedback, and/or opinions from the user pertaining to the business for transmitting from said personal mobile computing device to said server.

11. The method of claim 10, wherein said business campaign is launched by the user using a QR code; or by activating an application that is pre-installed on the personal mobile computing device and activated by the user entering a passcode; or by activating a URL embedded in a document.

12. The method of claim 10, wherein said plurality of screens include at least one of the following question screen types:
a two-scale question;
a 3, 4, or 5 scale question;
net promoter score questions;
percentage questions;
a 5 star question;
a 10 star question
a 2-picture horizontal or vertical layout question;
a 3-picture horizontal or vertical layout question;
a 4-picture grid layout question;
a 6-picture horizontal or vertical layout question;
a 9-picture grid layout question; and/or
a large-grid layout question.

13. The method of claim 10, wherein said plurality of screens include an advertisement or promotion information screen type.

14. A method of editing photographs using a personal mobile computer device customized with specialized software for distributing commentary, the method comprising the steps of:
displaying a photograph on a display of the mobile computer device to provide a picture layer for editing;
executing the specialized software on the personal mobile computer device to provide photograph editing tools via a user interface on the mobile computer device to allow the user to edit the photograph picture layer;
executing the specialized software on the personal mobile computer device to provide a text object insert user interface on the mobile computer device to enable the user to select a text object type configured to accept and display textual information;
executing the specialized software on the personal mobile computer device to provide a rating sticker object insert user interface for selecting a desired one of a plurality of different rating sticker objects from a library, wherein the rating sticker objects are configured to use graphical objects to display a desired rating;
executing the specialized software on the personal mobile computer device to provide a rating sticker object edit user interface on the mobile computer device to enable user editing of the selected rating sticker object type, wherein said user editing includes allowing the user to move, zoom, rotate, and delete the selected rating sticker object type, and wherein the selected rating sticker object type can be configured by the user using an interface of the mobile computing to communicate a desired rating;
wherein said picture layer with inserted edited object(s) results in a composed picture;
executing the specialized software on the personal mobile computer device to provide a share interface on the mobile computer device to enable the user to select one of a plurality of options for sharing the composed picture;
providing an animation layer for providing animation functionality to one or more of the object(s) in said composed picture; and
the personal mobile computer device executing a communication function based on the selected one of the options for sharing the composed picture to share the composed picture with another computing device.

15. The method of claim 14, wherein said personalized computer device is a smart phone.

16. The method of claim 14, wherein said picture layer is configured in a grid adapted to impose one or more restrictions on the objects that can be inserted into said picture layer.

17. The method of claim 14, wherein said method is provided as part of a campaign associated with a business to include information related to a product or service.

18. The method of claim 17, wherein said method includes a step of providing the business with market information collected from the user of the personal mobile computing device regarding the product or service, wherein said market information is collected via the user executing the method using the personal mobile computing device.

19. A method of implementing a business campaign using a personal mobile computer device customized with specialized software for distributing commentary, opinions, and/or ratings, said method comprising the steps of:
launching said business campaign on said personal mobile computing device by accepting a QR code in the device, or by accepting a passcode for activating an application that is pre-installed on the device, or by activating a URL embedded in a document displayed by the device;
providing a user with a plurality of preconfigured screens by communicating information from a server to said personal mobile computing device, wherein said plurality of preconfigured screens includes one or more question screens configured to ask the user a question, and one or more information screens configured to provide information to the user, and wherein said screens are display to the user in a predetermined order or in an order determined by a user response to one of the question screens;
using said one or more question screens to collect ratings, feedback, and/or opinions from the user pertaining to the business;
using said one or more information screens to display an advertisement or promotion, or information about a specific business campaign; and
the personal mobile computing device transmitting the collected ratings, feedback, and/or opinions from said personal mobile computing device to said server, wherein
an animation layer is provided to animate at least some of the information provided on one or more of said screens.

20. The method of claim 19, wherein said plurality of screens include at least one of the following question screen types:
a two-scale question;
a 3, 4, or 5 scale question;
net promoter score questions;
percentage questions;
a 5 star question;
a 10 star question
a 2-picture horizontal or vertical layout question;
a 3-picture horizontal or vertical layout question;
a 4-picture grid layout question;
a 6-picture horizontal or vertical layout question;
a 9-picture grid layout question; and/or
a large-grid layout question.
